(19) United States
(12) Patent Application Publication
(10) Pub. No.: US 2017/0091454 A1
(43) Pub. Date: Mar. 30, 2017

(54) LBR-BASED ROP/JOP EXPLOIT DETECTION

(71) Applicants: Vadim Sukhomlinov, Santa Clara, CA (US); Oleksandr Bazhaniuk, Hillsboro, OR (US); Igor Muttik, Aylesbury (GB); Yuriy Bulygin, Beaverton, OR (US); Alex Nayshtut, Gan Yavne (IS); Andrew A. Furtak, Beaverton, OR (US)

(72) Inventors: Vadim Sukhomlinov, Santa Clara, CA (US); Oleksandr Bazhaniuk, Hillsboro, OR (US); Igor Muttik, Aylesbury (GB); Yuriy Bulygin, Beaverton, OR (US); Alex Nayshtut, Gan Yavne (IS); Andrew A. Furtak, Beaverton, OR (US)

(21) Appl. No.: 14/865,954

(22) Filed: Sep. 25, 2015

(51) Int. Cl. G06F 21/56

(52) U.S. Cl. CPC G06F 21/566; G06F 2221/034

(57) ABSTRACT

Existing performance monitoring and last branch recording processor hardware may be configured and used for detection of return-oriented and jump-oriented programming exploits with less performance impact that software-only techniques. Upon generation of a performance monitoring interrupt indicating that a predetermined number of mispredicted branches have occurred, the control flow and code may be analyzed to detect a return-oriented or jump-oriented exploit.

### TECHNICAL FIELD

Embodiments described herein generally relate to techniques for detecting jump oriented programming exploits.

### BACKGROUND ART

Return and jump oriented programming (ROP/JOP) exploits are a growing threat for software applications. This technique allows an attacker to execute code even if security measures such as non-executable memory and code signing are used. In ROP, an attacker gains control of the call stack and then executes carefully chosen machine instruction sequences, called “gadgets.” Each gadget typically ends in a return instruction and is code within an existing program (or library). Chained together via a sequence of carefully crafted return addresses, these gadgets allow an attacker to perform arbitrary operations. JOP attacks do not depend upon the stack for control flow, but use a dispatcher gadget to take the role of executing functional gadgets that perform primitive operations.

Detection of ROP exploits is complicated due to the nature of the attack. A number of techniques have been proposed to subvert attacks based on return-oriented programming.

The first approach is randomizing the location of program and library code, so that an attacker cannot accurately predict the location of usable gadgets. Address space layout randomization (ASLR) is an example of this approach. Unfortunately, ASLR is vulnerable to information leakage attacks and once the code location is inferred, a return-oriented programming attack can still be constructed. Randomization approach can be taken further by employing relocation at runtime. This complicates the process of finding gadgets but incurs significant overhead.

Second approach, taken by kBouncer, modifies the operating system to track that return instructions actually divert control flow back to a location immediately following a call instruction. This prevents gadget chaining, but carries a heavy performance penalty. In addition, it is possible to mount JOP attacks without using return instructions at all, by using JMP instructions. kBouncer is not effective against JOP attacks.

Thirdly, some Intrusion Protection System (IPS) invalidate memory pages of a process except one currently executed page. Most regular jumps land within the same page. Passing control flow to a different page causes an exception which allows the IPS to check the control flow. This technique may also introduce a noticeable overhead.

Finally, there is work in progress targeting hardware-assisted ROP detection based on a series of sequentially mispredicted RET instructions. While providing a high detection rate, the technique is not currently available and will only be available in future processors.

Better approaches to both ROP and JOP attacks that does not incur large performance penalties would be desirable.

### BRIEF DESCRIPTION OF DRAWINGS

FIG. 1 is a block diagram illustrating an example of existing performance monitor hardware that may be used for the exploit detection techniques described below.

FIG. 2 is a block diagram illustrating an example of existing last branch recording hardware that may be used for the exploit detection techniques described below.

FIG. 3 is a block diagram illustrating a system for detecting return-oriented and jump oriented programming exploits according to one embodiment.

FIG. 4 is a flowchart illustrating a hardware-assisted technique for detecting return-oriented and jump-oriented programming exploits according to one embodiment.

FIGS. 5-6 are block diagrams illustrating two embodiments of programmable devices in which the techniques described herein may be implemented.

### DESCRIPTION OF EMBODIMENTS

In the following description, for purposes of explanation, numerous specific details are set forth in order to provide a thorough understanding of the invention. It will be apparent, however, to one skilled in the art that the invention may be practiced without these specific details. In other instances, structure and devices are shown in block diagram form in order to avoid obscuring the invention. References to numbers without subscripts or suffixes are understood to reference all instance of subscripts and suffixes corresponding to the referenced number. Moreover, the language used in this disclosure has been principally selected for readability and instructional purposes, and may not have been selected to delineate or circumscribe the inventive subject matter, resort to the claims being necessary to determine such inventive subject matter. Reference in the specification to “one embodiment” or to “an embodiment” means that a particular feature, structure, or characteristic described in connection with the embodiments is included in at least one embodiment of the invention, and multiple references to “one embodiment” or “an embodiment” should not be understood as necessarily all referring to the same embodiment.

As used herein, the term “a computer system” can refer to a single computer or a plurality of computers working together to perform the function described as being performed on or by a computer system.

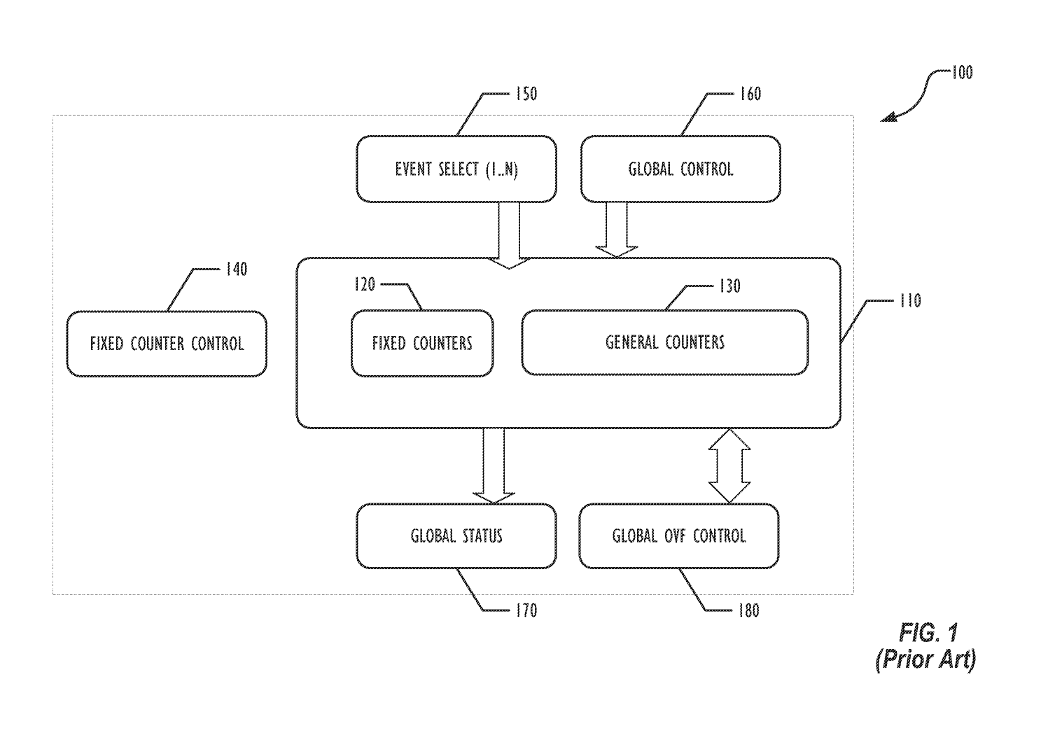

Modern computer processors have a Performance Monitoring Unit (PMU) for monitoring selected events. The diagram in FIG. 1 illustrates the core PMU and related registers 100 on Intel x86 processors. Processors from different manufacturers may have similar PMUs, although architectural details may differ. The PMU 110 has a plurality of fixed purpose counters 120. Each fixed purpose counter 120 can count only one architectural performance event, thus simplifying the configuration part. In addition to the fixed purpose counters 120, the Core PMU also supports a plurality of general purpose counters 130 that are capable of counting any activity occurring in the core. Each Core PMU 110 also has a set of control registers 140, 160, to assist with programming the fixed purpose counters 120 and general purpose counters 130. The PMU 110 also has Event Select registers 150 that correspond to each fixed purpose counter 120 and general purpose counter 130, which allows for specification of the exact event that should be counted. A global control register 160 allows enabling or disabling the counters 120, 130. A global status register 170 allows software to query counter overflow conditions on combinations of fixed purpose counters 120 and general purpose counters 130. A global overflow control register 180 allows software to clear counter overflow conditions on any combination of fixed-purpose counters 120 and general purpose counters 130. The elements illustrated in FIG. 1 are illustrative and by way of example only, and other elements and arrangements of elements may be provided as desired.

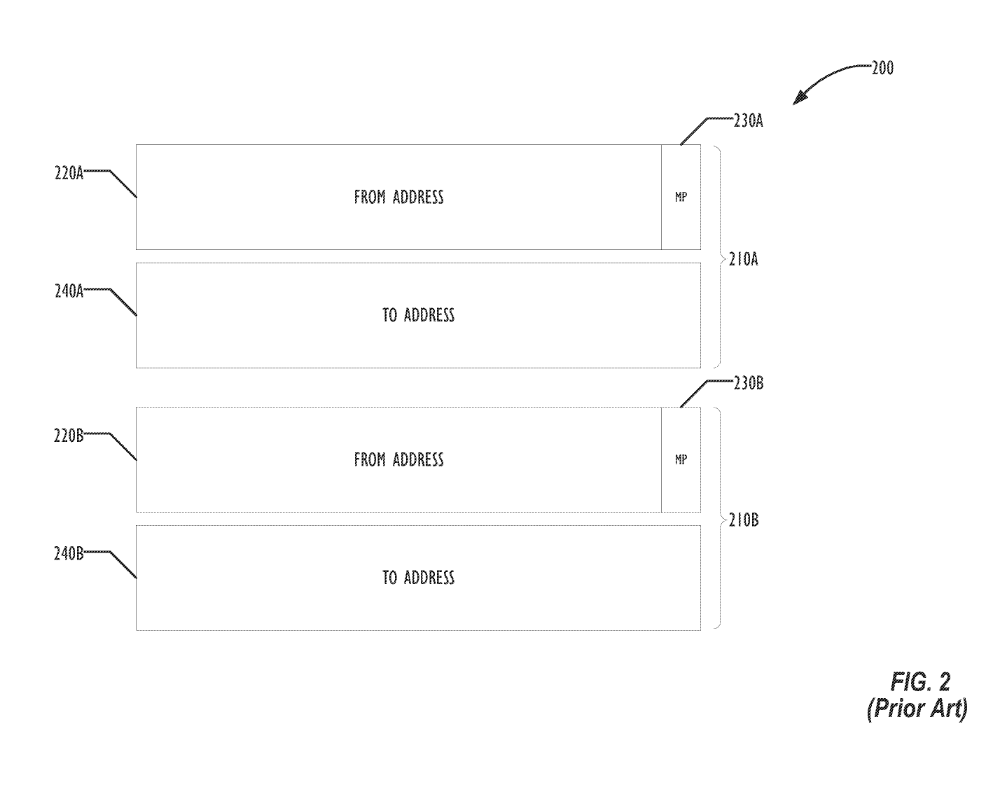

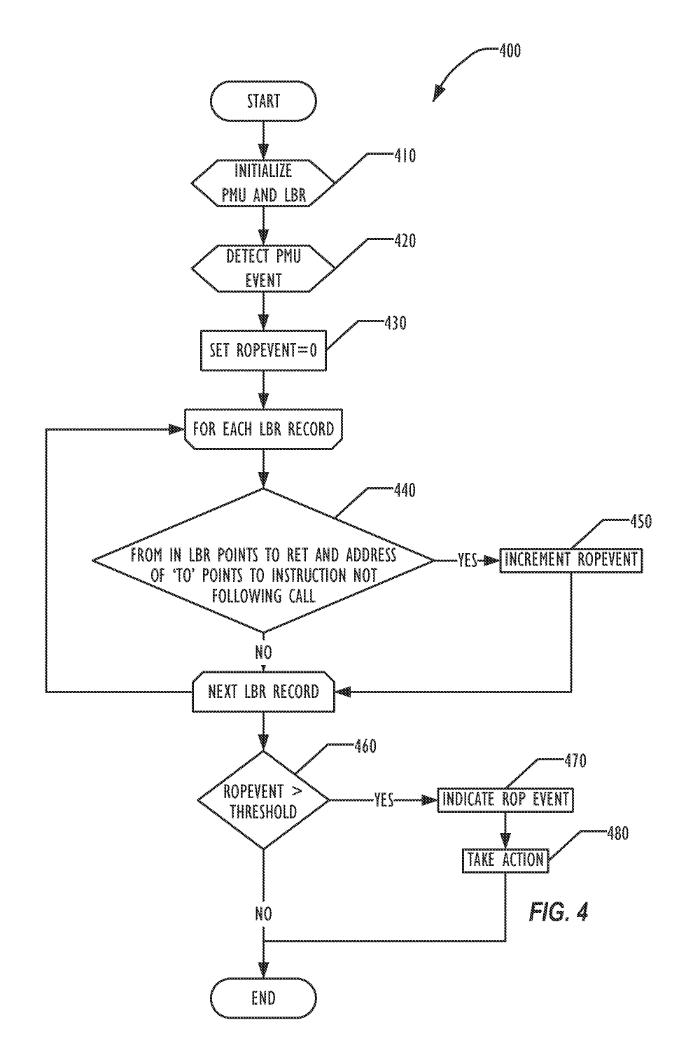

Modern processor architectures also provide a branch recording mechanism. Typically, the last branch recording mechanism tracks not only branch instructions (like JMP, Jcc, LOOP, and CALL instructions), but also other operations that cause a change in the instruction pointer, like external interrupts, traps, and faults. The branch recording mechanisms generally employ a set of processor model specific registers, referred to as a last branch record (LBR) stack, each entry of which stores a source address and a destination address of the last branch, thus the LBR stack provides a record of recent branches. Some embodiments of an LBR stack may also record an indication of whether the branch was mispredicted, i.e., one or more of the target of the branch and the direction (taken, not taken) was mispredicted. In addition, control registers may allow the processor to filter which kinds of branches are to be captured in the LBR stack. FIG. 2 is a block diagram illustrating an LBR stack 200 with two sets of registers 210A and 210B. Each LBR stack entry 210 includes one register with a from address field 220 and a mispredicted indicator 230, and another register with a to address field 240. Although only 2 LBR stack entries 210 are illustrated in the LBR stack 200 of FIG. 4 for clarity, implementations typically have more LBR stack entries 210. Although illustrated with the mispredict indicator as part of the register containing the from address 220, embodiments may place the mispredict indicator as part of the register containing the to address 240, or may place the mispredict indicator in a third register (not shown in FIG. 4). Other fields may be included in the LBR stack 200 as desired.

One of the ways the Event Select registers 150 may be configured is to cause the PMU 110 to count branch mispredict events. These events may be caused by ROP and JOP exploits, as well as for other reasons. Where branch capture filtering is available, the filter may be employed to limit the captured branches to those of interest in ROP or JOP exploits. For JOP exploits, the branches of interest are typically near indirect jumps. For ROP exploits, the branches of interest are typically CALLs or RETs. However, embodiments may filter other types of branches or do no branch capture filtering, if desired. For example, another type of exploit, known as call oriented programming (COP), uses gadgets that end with indirect CALL instructions. In COP exploits, gadgets are chained together by pointing the memory-indirect locations to the next gadget in sequence. COP exploits may be detected using a similar approach to that used for detecting ROP and JOP exploits, with the branches of interest being CALLs.

By using these facilities, embodiments disclosed herein can detect ROP and JOP exploits without significant processor overhead.

The PMU 110 is configured to count branch mispredict events caused by ROP or JOP exploit. The LBR registers are configured to store the relevant branch records.

When a mispredict event occurs (or, preferably, when a mispredict count exceeds a predetermined threshold) the reason for the misprediction may be analyzed by matching the expected program code flow with the real one extracted from the LBR stack 200. The analysis is fairly simple because the from and to addresses 220, 240 are readily available from the LBR stack 200 and the from and to addresses directly point to the code in question, allowing separating valid reasons (say, indirect CALL or deep recursion) from exploit behavior (by employing, for example, static code flow analysis of the program).

Using the hardware PMU and related registers 100 and the LBR stack 200 to collect mispredicted branch data for analysis introduces the following advantages:

1. Low overhead compared to all existing methods (all events are gathered by CPU via PMU 110 and LBR stack 200).

2. Ease of analysis: LBR event data points exactly to the suspected code.

3. High ROP/JOP detection rate with an ability to fine-tune the sensitivity and minimize the false positive rate.

4. Generic to majority of processor platforms: most recent processor platforms already have all the hardware needed for implementing this invention.

5. Operating system (OS) agnostic: events collection is fully hardware-based, with no OS interaction or enablement needed.

6. Resilience to OS, Hypervisor, Basic Input/Output System (BIOS), and Unified Extensible Firmware Interface (UEFI) malware: even in the presence of an OS or firmware-based malware, events will be reliably collected and securely delivered to the monitoring agent.

7. PMU logic allows counting mispredicted RET instructions and enabling a PMU interrupt (PMI) once the counter reach a predetermined threshold. This provides additional hardware-supported sensitivity control to maximize the true positive rates (fine-tuning will allow catching the smallest observed ROP/JOP shellcode sequences). Not every mispredicted branch indicates an exploit. In one embodiment, the threshold value may be empirically determined, based on analysis of detected ROP and JOP exploits. In some embodiments, the threshold value may be configured based on a policy.

An implementation according to one embodiment comprises the following components:

1. PMU 110 event counters, reporting address of instruction, that can indicate various conditions: (a) mispredicted branches for JMP and RET instructions; and (optionally to assist code analysis) (b) memory, I/O, and cache usage, debug instructions and self-modifying code, (c) crypto opcode statistics; and (d) typical patterns of exploitations (changes of stack pointer).

2. An LBR stack 200 configured to store addresses of transitions caused by JMPs/CALLs/RETs.

3. A PMI handler, implementing collection of counters data and LBR data.

4. A software handler for processing the PMU counters, LBR data and providing a verdict whether actual code flow matches an expected one. This analysis may employ either static or dynamic code flow analysis; for example, code de-compilation or partial code emulation to obtain the expected code flow. A heuristic and/or analytics approach may also be taken to reach the verdict. Many ways to perform the analysis may be used as desired, based on any chosen form of code analysis. One heuristic approach described below.

5. An interface to security software or reporting tools to implement actions/policies in case of detection.

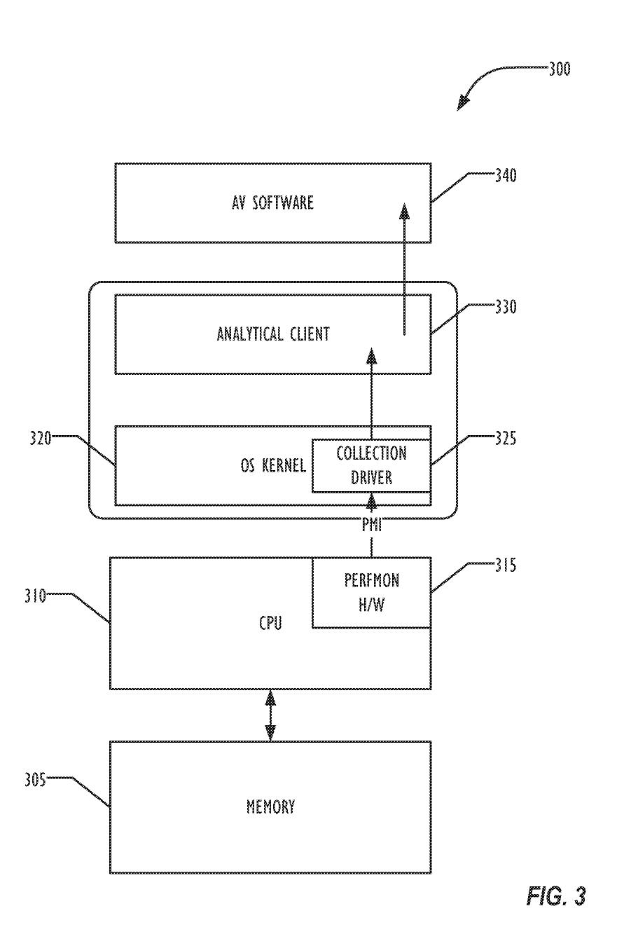

FIG. 3 is a block diagram illustrating a system 300 for ROP and JOP detection based on these hardware counters and LBR data according to one embodiment. As described above, the processor 310 includes hardware performance monitoring elements 315 including the PMU and related control registers 100, as well as the LBR stack 200. Upon generation of a performance monitoring interrupt (PMI), which may be caused by one of the PMU counters exceeding or meeting a configured threshold value, a collection driver 325, typically implemented as part of a kernel of the OS 320, captures the PMU counter data and the LBR stack data. An analytical client module 330 may then be passed the collected data for performing analysis on the mispredicted jump data. Finally, an anti-malware software 340 may take action, based on the analysis, such as terminating, sandboxing, quarantining, reporting, and/or monitoring the software whose execution triggered the mispredicted branch analysis. The OS 320 need not be specifically enabled for the collection driver 325. Although the implementation of the collection driver 325 and analytical engine 330 may vary from OS to OS, their general behavior is independent of the OS. Although illustrated as implemented as part of the OS kernel, some of the collection driver 325 may be implemented in user mode in some embodiments, and the analytical client 330 typically is implemented as user mode code, rather than privileged mode code.

A memory 305 coupled to the processor 310 may be used for storage of information related to the detection and analysis techniques described herein. The memory may be connected to the processor in any desired way, including busses, point-to-point interconnects, etc. The memory may be also be used for storing instructions that when executed cause the computer 300 to execute the collection driver 325, the analytical client 330, and the anti-malware software 340.

One skilled in the art will recognize that other conventional elements of a computer system or other programmable device may be included in the system 300, such as a keyboard, pointing device, displays, etc.

Processor 310 may comprise, for example, a microprocessor, microcontroller, digital signal processor (DSP), application specific integrated circuit (ASIC), or any other digital or analog circuitry configured to interpret and/or execute program instructions and/or process data. In some embodiments, processor 310 may interpret and/or execute program instructions and/or process data stored in memory 305. Memory 305 may be configured in part or whole as application memory, system memory, or both. Memory 305 may include any system, device, or apparatus configured to hold and/or house one or more memory modules. Each memory module may include any system, device or apparatus configured to retain program instructions and/or data for a period of time (e.g., computer-readable storage media). Instructions, logic, or data for configuring the operation of system 300, such as configurations of components such as the performance monitoring hardware 315, the collection driver 325, the analytical client 330, or anti-malware software 340 may reside in memory 305 for execution by processor 310.

While a single processor 310 is illustrated in FIG. 3, the system 300 may include multiple processors. Furthermore, processor 310 may include multiple cores or central processing units.

Memory 305 may include one or more memory modules and comprise random access memory (RAM), read only memory (ROM), programmable read only memory (PROM), programmable read-write memory, and solid-state memory. Memory 305 may also include a storage device providing any form of non-volatile storage including, but not limited to, all forms of optical and magnetic, including solid-state storage elements, including removable media. The storage device may be a program storage device used for storage of software to control computer 300, data for use by the computer 300 (including performance monitoring configuration data), or both. The instructions for configuring the performance monitoring hardware as well as for processing PMIs and analyzing the collected data may be provided on one or more machine readable media, used either as part of the memory 305 or for loading the instructions from the media into the memory 305. Although only a single memory 305 is illustrated in FIG. 3 for clarity, any number of memory devices, including any number of storage devices, may be provided as desired as part of the memory 305.

The computer system 300 may be any type of computing device, such as, for example, a smart phone, smart tablet, personal digital assistant (PDA), mobile Internet device, convertible tablet, notebook computer, desktop computer, server, or smart television.

FIG. 4 is a flowchart illustrating a procedure 400 for detecting ROP and JOP exploits according to one embodiment. In block 410, the PMU and LBR hardware is initialized. The PMU 110 is configured to count branch mispredicted RET and/or JMP events. In addition, other events related to branches and other instructions affecting the execution flow may be configured for counting by the PMU counters 120 and 130. The LBR stack 200 is also configured to store addresses of RET and JMP transitions. In some embodiments, the LBR stack 200 stores all such branches, whether or not the branch was mispredicted.

In block 420, a PMU event is detected by the collection driver 325 upon generation of a PMI. The registers of the PMU and control registers 100 are interrogated to determine which PMU event caused the PMI. The collection driver 325 may also read a block of memory at the address of interrupt (obtained from the stack), read the content of the LBR stack 200, and read the content of memory pointed to by LBR entries (from and to addresses). The collection driver 325 may then forward the collected information to the analytical client for analysis.

Blocks 430-470 implement a simple heuristic analysis approach that may be used to determine whether a ROP or JOP event has occurred according to one embodiment. This heuristic is illustrative and by way of example only. Other heuristics may be used instead of or in addition to the illustrated heuristic. Alternately, the analytical client may perform code analysis (static, dynamic, or both, as desired). This analysis may be performed locally by security software or the expected fingerprint may be created externally (e.g., by the compiler and/or linker or by recording typical execution patterns in controlled environment), delivered along with the software or dynamically queried through the network and compared to the observed to/from addresses when a ROPevent 430 occurs. Techniques such as code decompilation or partial code emulation to obtain the expected code flow and compare the expected code flow with the actual code flow may be used. In one embodiment, whitelists may be used to list from/to address pairs that are known to be good; alternately, a blacklist of known bad from/to address pairs may be used. A combination of a whitelist and a blacklist may also be used.

As illustrated in FIG. 4, the heuristic is designed for detection of ROP exploits. An ROPEVENT counter is initialized in block 430, as illustrated by setting the counter to 0. Block 440 and possibly block 450 are performed for each LBR record or entry 210 in the LBR stack 200. In block 440, the analytical client determines whether the from address 220 points to a RET instruction and the to address points to an instruction that does not immediately follow a CALL instruction. If both conditions exist, the ROPEVENT counter is incremented in block 450.

After all LBR entries 210 are considered, if the ROPEVENT counter exceeds a predetermined threshold value in block 460, an ROP event is signaled or indicated in block 470. In alternate embodiments, the ROP event is signaled or indicated if the ROPEVENT counter meets or exceeds the threshold value.

In other embodiments, instead of initializing the ROPEVENT counter to zero and incrementing it each time a RET points to an address not following a CALL, the ROPEVENT counter may be set to a predetermined threshold value and repeatedly decremented. In such an embodiment, an ROP event may be indicated if the ROPEVENT counter reaches 0 or any other predetermined low threshold value.

Finally, in block 480, security software 340 (anti-malware or host intrusion protection system software) may take an action responsive to the determination that an ROP event has occurred.

Advanced analytics in addition may take into account additional contextual data and implement extra checks based on other factors, such as:

1. Distribution of from/to addresses.

2. Uniqueness of from, to and from/to addresses.

3. Matching of from/to addresses and other PMU counters to a distribution that characterizes the specific process (software fingerprinting).

By taking into account the address of the instruction causing the PMI (which is stored on the stack) raised by reaching threshold of counter, the analytical client 330 may determine which process was responsible for the PMI, and may limit the analysis to specific monitored processes. For example, the analytical client 330 may filter only addresses belonging to the address space of the monitored process. In some embodiments, the data about process location in memory is available from the OS thru Process Walking or enumerating processes. Embodiments may exclude certain processes to suppress incorrect detections or to improve system performance. The analytical client may analyze the time sequence of specific counters for a selected process as well as the distribution of the addresses of instructions causing those events. In addition, the distribution of branch misprediction instructions may be used to form a software fingerprint.

The simple heuristic illustrated in FIG. 4 is designed for detection of ROP events. To handle JOP exploits, the PMU hardware 100 may be configured to catch mispredicted JMPs (conditional and/or unconditional); similarly, the LBR stack may be configured to capture RET and indirect JMP events (NEAR_RET and NEAR_IND_JMP). In our experiments the frequency of mispredicted indirect jumps can be higher than that of RETs. The code analysis and heuristics are a bit more complex, and the analysis looks for a sequence of LBR from addresses pointing to an indirect jump instruction with an alternating constant address of a dispatcher's entry point and leave point (if only 1 dispatcher is active). If multiple dispatchers are in use, then the analytical client 330 may look for a sequence of indirect jumps in LBRs 210.

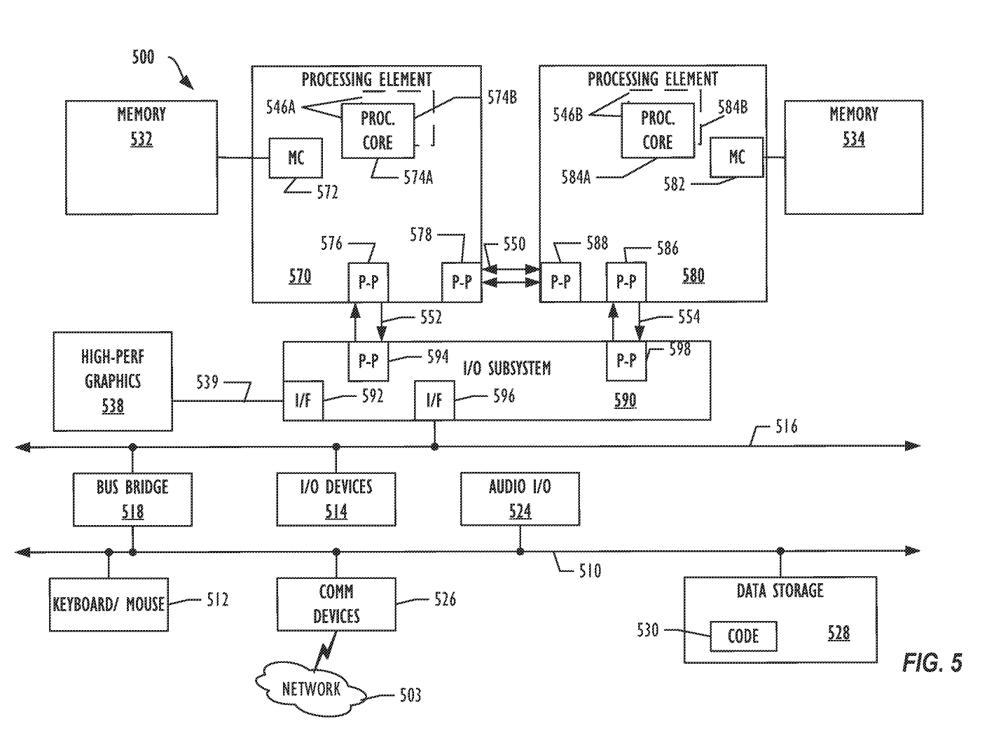

Referring now to FIG. 5, a block diagram illustrates a programmable device 500 that may be used for implementing the techniques described herein in accordance with one embodiment. The programmable device 500 illustrated in FIG. 5 is a multiprocessor programmable device that includes a first processing element 570 and a second processing element 580. While two processing elements 570 and 580 are shown, an embodiment of programmable device 500 may also include only one such processing element.

Programmable device 500 is illustrated as a point-to-point interconnect system, in which the first processing element 570 and second processing element 580 are coupled via a point-to-point interconnect 550. Any or all of the interconnects illustrated in FIG. 5may be implemented as a multi-drop bus rather than point-to-point interconnects.

As illustrated in FIG. 5, each of processing elements 570 and 580 may be multicore processors, including first and second processor cores (i.e., processor cores 574a and 574b and processor cores 584a and 584b). Such cores 574a, 574b, 584a, 584b may be configured to execute instruction code. However, other embodiments may use processing elements that are single core processors as desired. In embodiments with multiple processing elements 570, 580, each processing element may be implemented with different numbers of cores as desired.

Each processing element 570, 580 may include at least one shared cache 546. The shared cache 546a, 546b may store data (e.g., instructions) that are utilized by one or more components of the processing element, such as the cores 574a, 574b and 584a, 584b, respectively. For example, the shared cache may locally cache data stored in a memory 532, 534 for faster access by components of the processing elements 570, 580. In one or more embodiments, the shared cache 546a, 546b may include one or more mid-level caches, such as level 2 (L2), level 3 (L3), level 4 (L4), or other levels of cache, a last level cache (LLC), or combinations thereof

While FIG. 5 illustrates a programmable device with two processing elements 570, 580 for clarity of the drawing, the scope of the present invention is not so limited and any number of processing elements may be present. Alternatively, one or more of processing elements 570, 580 may be an element other than a processor, such as an graphics processing unit (GPU), a digital signal processing (DSP) unit, a field programmable gate array, or any other programmable processing element. Processing element 580 may be heterogeneous or asymmetric to processing element 570. There may be a variety of differences between processing elements 570, 580 in terms of a spectrum of metrics of merit including architectural, microarchitectural, thermal, power consumption characteristics, and the like. These differences may effectively manifest themselves as asymmetry and heterogeneity amongst processing elements 570, 580. In some embodiments, the various processing elements 570, 580 may reside in the same die package.

First processing element 570 may further include memory controller logic (MC) 572 and point-to-point (P-P) interconnects 576 and 578. Similarly, second processing element 580 may include a MC 582 and P-P interconnects 586 and 588. As illustrated in FIG. 5, MCs 572 and 582 couple processing elements 570, 580 to respective memories, namely a memory 532 and a memory 534, which may be portions of main memory locally attached to the respective processors. While MC logic 572 and 582 is illustrated as integrated into processing elements 570, 580, in some embodiments the memory controller logic may be discrete logic outside processing elements 570, 580 rather than integrated therein.

Processing element 570 and processing element 580 may be coupled to an I/O subsystem 590 via respective P-P interconnects 576 and 586 through links 552 and 554. As illustrated in FIG. 5, I/O subsystem 590 includes P-P interconnects 594 and 598. Furthermore, I/O subsystem 590 includes an interface 592 to couple I/O subsystem 590 with a high performance graphics engine 538. In one embodiment, a bus (not shown) may be used to couple graphics engine 538 to I/O subsystem 590. Alternately, a point-to-point interconnect 539 may couple these components.

In turn, I/O subsystem 590 may be coupled to a first link 516 via an interface 596. In one embodiment, first link 516 may be a Peripheral Component Interconnect (PCI) bus, or a bus such as a PCI Express bus or another I/O interconnect bus, although the scope of the present invention is not so limited.

As illustrated in FIG. 5, various I/O devices 514, 524 may be coupled to first link 516, along with a bridge 518 that may couple first link 516 to a second link 520. In one embodiment, second link 520 may be a low pin count (LPC) bus. Various devices may be coupled to second link 520 including, for example, a keyboard/mouse 512, communication device(s) 526 (which may in turn be in communication with the computer network 503), and a data storage unit 528 such as a disk drive or other mass storage device which may include code 530, in one embodiment. The code 530 may include instructions for performing embodiments of one or more of the techniques described above. Further, an audio I/O 524 may be coupled to second link 520.

Note that other embodiments are contemplated. For example, instead of the point-to-point architecture of FIG. 5, a system may implement a multi-drop bus or another such communication topology. Although links 516 and 520 are illustrated as busses in FIG. 5, any desired type of link may be used. In addition, the elements of FIG. 5 may alternatively be partitioned using more or fewer integrated chips than illustrated in FIG. 5.

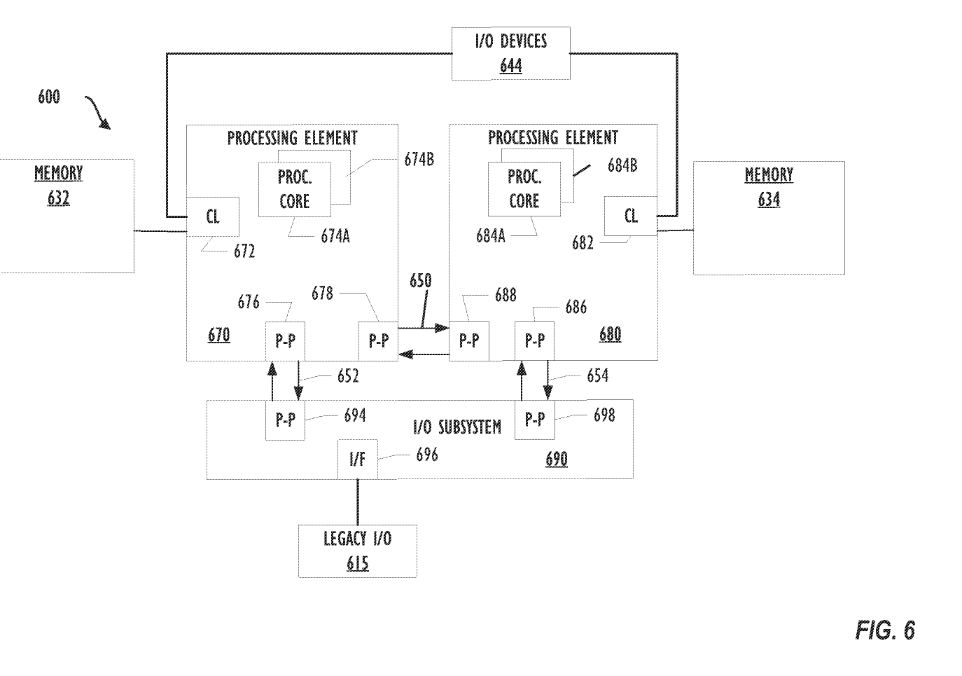

Referring now to FIG. 6, a block diagram illustrates a programmable device 600 according to another embodiment. Certain aspects of FIG. 6 have been omitted from FIG. 6 in order to avoid obscuring other aspects of FIG. 6.

FIG. 6 illustrates that processing elements 670, 680 may include integrated memory and I/O control logic (“CL”) 672 and 682, respectively. In some embodiments, the 672, 682 may include memory control logic (MC) such as that described above in connection with FIG. 5. In addition, CL 672, 682 may also include I/O control logic. FIG. 6 illustrates that not only may the memories 632, 634 be coupled to the CL 672, 682, but also that I/O devices 644 may also be coupled to the control logic 672, 682. Legacy I/O devices 615 may be coupled to the I/O subsystem 690 by interface 696. Each processing element 670, 680 may include multiple processor cores, illustrated in FIG. 6 as processor cores 674A, 674B, 684A and 684B. As illustrated in FIG. 6, I/O subsystem 690 includes point-to-point (P-P) interconnects 694 and 698 that connect to P-P interconnects 676 and 686 of the processing elements 670 and 680 with links 652 and 654. Processing elements 670 and 680 may also be interconnected by link 650 and interconnects 678 and 688, respectively.

The programmable devices depicted in FIGS. 5 and 6 are schematic illustrations of embodiments of programmable devices that may be utilized to implement various embodiments discussed herein. Various components of the programmable devices depicted in FIGS. 5 and 6 may be combined in a system-on-a-chip (SoC) architecture.

Although embodiments are described above that are directed at either return-oriented or jump-oriented programming exploits, in some embodiments both types of exploits may be detected by combining the techniques described above.

The techniques described above may be implemented as part of any desired type of anti-malware system, such as an intrusion protection system. By using hardware performance monitoring capability and last branch recording, the techniques may be used to detect relatively difficult-to-detect ROP and JOP exploits without the need for a specific signature of the exploit, and with less performance impact than a purely software-based technique as has been discussed in the literature previously. Furthermore, proper design of the analytical engine may avoid the negative impact of false positives in the analysis.

The following examples pertain to further embodiments.

Example 1 is a machine readable medium, on which are stored instructions, comprising instructions that when executed cause a programmable device to: configure hardware performance monitoring counters to count mispredicted branches; configure a hardware last branch mechanism to capture a predetermined category of branches; collect performance monitoring counter data and last branch data responsive to an interrupt generated upon a predetermined condition of the hardware performance monitoring counters; and analyze the performance monitoring counter data and the last branch data to determine whether a malware exploit has occurred.

In Example 2 the subject matter of Example 1 optionally includes wherein the malware exploit is a return-oriented programming exploit.

In Example 3 the subject matter of Example 2 optionally includes wherein the instructions that when executed cause the programmable device to analyze the performance monitoring counter data and the last branch data to determine whether a malware exploit has occurred comprise instructions that when executed cause the programmable device to: count last branch instances having a from address pointing to a return instruction and a to address pointing to an instruction not following a call instruction; modify a return-oriented programming event counter; and indicate a return-oriented programming event responsive to the return-oriented programming event counter having a predetermined relation to a predetermined threshold value.

In Example 4 the subject matter of Example 1 optionally includes wherein the malware exploit is a jump-oriented programming exploit.

In Example 5 the subject matter of Example 4 optionally includes wherein the instructions that when executed cause the programmable device to analyze the performance monitoring counter data and the last branch data to determine whether a malware exploit has occurred comprise instructions that when executed cause the programmable device to: look for a sequence of last branch instances having from addresses pointing to an indirect jump instruction with an alternating constant address of a dispatcher's entry point and leave point.

In Example 6 the subject matter of Example 1 optionally includes wherein the predetermined category of branches comprises return instructions.

In Example 7 the subject matter of Example 1 optionally includes wherein the predetermined category of branches comprises near indirect jump instructions.

In Example 8 the subject matter of Examples 1-7 optionally includes wherein the instructions further comprise instructions that when executed cause the programmable device to: take an anti-malware action responsive to a determination that a malware exploit has occurred, wherein the anti-malware action comprises one or more of termination or changing a sensitivity of a monitoring behavior of a program that triggered the malware exploit.

Example 9 is a programmable device programmed to detect malware exploits, comprising: a processor, comprising: a performance monitoring unit; and a last branch record stack; and a memory, coupled to the processor, on which are stored instructions, comprising instructions that when executed cause the processor to: configure the performance monitoring unit to count mispredicted branches; configure the last branch record stack to capture a predetermined category of branches; collect mispredicted branch counts and last branch data from the performance monitoring unit and last branch record stack, responsive to an interrupt generated upon a predetermined condition of the performance monitoring unit; and analyze the mispredicted branch counts and the last branch data to determine whether a malware exploit has occurred.

In Example 10 the subject matter of Example 9 optionally includes wherein the malware exploit is a return-oriented programming exploit.

In Example 11 the subject matter of Example 10 optionally includes wherein the instructions that when executed cause the processor to analyze the mispredicted branch counts and the last branch data comprise instructions that when executed cause the processor to: increment a return-oriented programming event counter responsive to a last branch instance having a from address pointing to a return instruction and a to address pointing to an instruction not following a call instruction; and indicate a return-oriented programming exploit has occurred responsive to the return-oriented programming event counter meeting or exceeding a predetermined threshold value.

In Example 12 the subject matter of Example 10 optionally includes wherein the predetermined category of branches comprises return instructions.

In Example 13 the subject matter of Example 9 optionally includes wherein the malware exploit is a jump-oriented programming exploit.

In Example 14 the subject matter of Example 13 optionally includes wherein the instructions that when executed cause the processor to analyze the mispredicted branch counts and the last branch data comprise instructions that when executed cause the processor to: look for a sequence of last branch instances having from addresses pointing to an indirect jump instruction with an alternating constant address of a dispatcher's entry point and leave point.

In Example 15 the subject matter of Example 13 optionally includes wherein the predetermined category of branches comprises near indirect jump instructions.

In Example 16 the subject matter of Examples 9-15 optionally includes wherein the instructions further comprise instructions that when executed cause the processor to: take an anti-malware action responsive to a determination that that a malware exploit has occurred.

Example 17 is a method of detecting malware exploits, comprising: counting mispredicted branches in a performance monitoring unit of a processor; capturing last branch information by the processor; collecting a mispredicted branch count and the last branch information responsive to a performance monitoring interrupt; and determining whether a malware exploit has occurred based on the mispredicted branch count and last branch information.

In Example 18 the subject matter of Example 17 optionally includes wherein counting mispredicted branches comprises configuring a control register of the performance monitoring unit to cause the performance monitoring unit to count mispredicted branches.

In Example 19 the subject matter of Example 17 optionally includes further comprising: configuring the performance monitoring unit to generate the performance monitoring interrupt responsive to counting a threshold number of mispredicted branches.

In Example 20 the subject matter of Examples 17-19 optionally includes wherein capturing last branch information comprises: configuring a last branch record unit to capture return instruction branches.

In Example 21 the subject matter of Examples 17-19 optionally includes wherein capturing last branch information comprises: configuring a last branch record unit to capture near indirect jump branches.

In Example 22 the subject matter of Examples 17-19 optionally includes wherein the malware exploit is a return-oriented programming exploit, and wherein determining whether a malware exploit has occurred comprises: counting occurrences of a last branch instance having a from address pointing to a return instruction and a to address pointing to an instruction not following a call instruction; and indicating the malware exploit has occurred responsive to a threshold number of occurrences.

In Example 23 the subject matter of Examples 17-19 optionally includes wherein the malware exploit is a jump-oriented programming exploit, and wherein determining whether a malware exploit has occurred comprises: finding a sequence of last branch instances having from addresses pointing to an indirect jump instructions alternating with a constant address of a dispatcher entry point or leave point.

In Example 24 the subject matter of Examples 17-19 optionally includes further comprising: taking an anti-malware action responsive to the determination that an exploit has occurred.

In Example 25 the subject matter of Examples 17-19 optionally includes wherein determining whether a malware exploit has occurred comprises detecting whether either of a return-oriented programming exploit or a jump-oriented programming exploit has occurred.

Example 26 is a programmable device, comprising: means for configuring hardware performance monitoring counters to count mispredicted branches; means for configuring a hardware last branch mechanism to capture a predetermined category of branches; means for collecting performance monitoring counter data and last branch data responsive to an interrupt generated upon a predetermined condition of the hardware performance monitoring counters; and means for analyzing the performance monitoring counter data and the last branch data to determine whether a malware exploit has occurred.

In Example 27 the subject matter of Example 26 optionally includes wherein the malware exploit is a return-oriented programming exploit.

In Example 28 the subject matter of Example 27 optionally includes wherein means for analyzing the performance monitoring counter data and the last branch data to determine whether a malware exploit has occurred comprises: means for counting last branch instances having a from address pointing to a return instruction and a to address pointing to an instruction not following a call instruction; means for modifying a return-oriented programming event counter; and means for indicating a return-oriented programming event responsive to the return-oriented programming event counter having a predetermined relation to a predetermined threshold value.

In Example 29 the subject matter of Example 26 optionally includes wherein the malware exploit is a jump-oriented programming exploit.

In Example 30 the subject matter of Example 29 optionally includes wherein the means for analyzing the performance monitoring counter data and the last branch data to determine whether a malware exploit has occurred comprises: means for looking for a sequence of last branch instances having from addresses pointing to an indirect jump instruction with an alternating constant address of a dispatcher's entry point and leave point.

In Example 31 the subject matter of Example 26 optionally includes wherein the predetermined category of branches comprises return instructions.

In Example 32 the subject matter of Example 26 optionally includes wherein the predetermined category of branches comprises near indirect jump instructions.

In Example 33 the subject matter of Examples 26-32 optionally includes wherein further comprising: means for taking an anti-malware action responsive to a determination that a malware exploit has occurred, wherein the anti-malware action comprises one or more of termination or changing a sensitivity of a monitoring behavior of a program that triggered the malware exploit.

Example 34 is a machine readable medium, on which are stored instructions, comprising instructions that when executed cause a programmable device to: configure hardware performance monitoring counters to count mispredicted branches; configure a hardware last branch mechanism to capture a predetermined category of branches; collect performance monitoring counter data and last branch data responsive to an interrupt generated upon a predetermined condition of the hardware performance monitoring counters; and analyze the performance monitoring counter data and the last branch data to determine whether a malware exploit has occurred.

In Example 35 the subject matter of Example 34 optionally includes wherein the instructions that when executed cause the programmable device to analyze the performance monitoring counter data and the last branch data to determine whether a malware exploit has occurred comprise instructions that when executed cause the programmable device to: count last branch instances having a from address pointing to a return instruction and a to address pointing to an instruction not following a call instruction; modify a return-oriented programming event counter; and indicate a return-oriented programming event responsive to the return-oriented programming event counter having a predetermined relation to a predetermined threshold value.

In Example 36 the subject matter of Example 34 optionally includes wherein the instructions that when executed cause the programmable device to analyze the performance monitoring counter data and the last branch data to determine whether a malware exploit has occurred comprise instructions that when executed cause the programmable device to: look for a sequence of last branch instances having from addresses pointing to an indirect jump instruction with an alternating constant address of a dispatcher's entry point and leave point.

In Example 37 the subject matter of Example 34 optionally includes wherein the predetermined category of branches comprises return instructions or near indirect jump instructions.

In Example 38 the subject matter of Examples 34-37 optionally includes wherein the instructions further comprise instructions that when executed cause the programmable device to: take an anti-malware action responsive to a determination that a malware exploit has occurred, wherein the anti-malware action comprises one or more of termination or changing a sensitivity of a monitoring behavior of a program that triggered the malware exploit.

Example 39 is a programmable device programmed to detect malware exploits, comprising: a processor, comprising: a performance monitoring unit; and a last branch record stack; and a memory, coupled to the processor, on which are stored instructions, comprising instructions that when executed cause the processor to: configure the performance monitoring unit to count mispredicted branches; configure the last branch record stack to capture a predetermined category of branches; collect mispredicted branch counts and last branch data from the performance monitoring unit and last branch record stack, responsive to an interrupt generated upon a predetermined condition of the performance monitoring unit; and analyze the mispredicted branch counts and the last branch data to determine whether a malware exploit has occurred.

In Example 40 the subject matter of Example 39 optionally includes wherein the instructions that when executed cause the processor to analyze the mispredicted branch counts and the last branch data comprise instructions that when executed cause the processor to: increment a return-oriented programming event counter responsive to a last branch instance having a from address pointing to a return instruction and a to address pointing to an instruction not following a call instruction; and indicate a return-oriented programming exploit has occurred responsive to the return-oriented programming event counter meeting or exceeding a predetermined threshold value.

In Example 41 the subject matter of Example 39 optionally includes the predetermined category of branches comprises return instructions or near indirect jump instructions.

In Example 42 the subject matter of Example 39 optionally includes wherein the instructions that when executed cause the processor to analyze the mispredicted branch counts and the last branch data comprise instructions that when executed cause the processor to: look for a sequence of last branch instances having from addresses pointing to an indirect jump instruction with an alternating constant address of a dispatcher's entry point and leave point.

In Example 43 the subject matter of Examples 39-42 optionally includes wherein the instructions further comprise instructions that when executed cause the processor to: take an anti-malware action responsive to a determination that that a malware exploit has occurred.

Example 44 is a method of detecting malware exploits, comprising: counting mispredicted branches in a performance monitoring unit of a processor; capturing last branch information by the processor; collecting a mispredicted branch count and the last branch information responsive to a performance monitoring interrupt; determining whether a malware exploit has occurred based on the mispredicted branch count and last branch information; and taking an anti-malware action responsive to the determination that an exploit has occurred.

In Example 45 the subject matter of Example 44 optionally includes wherein counting mispredicted branches comprises configuring a control register of the performance monitoring unit to cause the performance monitoring unit to count mispredicted branches, further comprising configuring the performance monitoring unit to generate the performance monitoring interrupt responsive to counting a threshold number of mispredicted branches.

In Example 46 the subject matter of Examples 44-45 optionally includes wherein capturing last branch information comprises: configuring a last branch record unit to capture return instruction branches or near indirect jump branches.

In Example 47 the subject matter of Examples 44-45 optionally includes wherein the malware exploit is a return-oriented programming exploit, and wherein determining whether a malware exploit has occurred comprises: counting occurrences of a last branch instance having a from address pointing to a return instruction and a to address pointing to an instruction not following a call instruction; and indicating the malware exploit has occurred responsive to a threshold number of occurrences.

In Example 48 the subject matter of Examples 44-45 optionally includes wherein the malware exploit is a jump-oriented programming exploit, and wherein determining whether a malware exploit has occurred comprises: finding a sequence of last branch instances having from addresses pointing to an indirect jump instructions alternating with a constant address of a dispatcher entry point or leave point.

It is to be understood that the above description is intended to be illustrative, and not restrictive. For example, the above-described embodiments may be used in combination with each other. Many other embodiments will be apparent to those of skill in the art upon reviewing the above description. The scope of the invention therefore should be determined with reference to the appended claims, along with the full scope of equivalents to which such claims are entitled.

What is claimed is:

1. A machine readable medium, on which are stored instructions, comprising instructions that when executed cause a programmable device to:
configure hardware performance monitoring counters to count mispredicted branches;
configure a hardware last branch mechanism to capture a predetermined category of branches;
collect performance monitoring counter data and last branch data responsive to an interrupt generated upon a predetermined condition of the hardware performance monitoring counters; and
analyze the performance monitoring counter data and the last branch data to determine whether a malware exploit has occurred.

2. The machine readable medium of claim 1, wherein the malware exploit is a return-oriented programming exploit.

3. The machine readable medium of claim 2, wherein the instructions that when executed cause the programmable device to analyze the performance monitoring counter data and the last branch data to determine whether a malware exploit has occurred comprise instructions that when executed cause the programmable device to:
count last branch instances having a from address pointing to a return instruction and a to address pointing to an instruction not following a call instruction;
modify a return-oriented programming event counter; and
indicate a return-oriented programming event responsive to the return-oriented programming event counter having a predetermined relation to a predetermined threshold value.

4. The machine readable medium of claim 1, wherein the malware exploit is a jump-oriented programming exploit.

5. The machine readable medium of claim 4, wherein the instructions that when executed cause the programmable device to analyze the performance monitoring counter data and the last branch data to determine whether a malware exploit has occurred comprise instructions that when executed cause the programmable device to:
look for a sequence of last branch instances having from addresses pointing to an indirect jump instruction with an alternating constant address of a dispatcher's entry point and leave point.

6. The machine readable medium of claim 1, wherein the predetermined category of branches comprises return instructions.

7. The machine readable medium of claim 1, wherein the predetermined category of branches comprises near indirect jump instructions.

8. The machine readable medium of claim 1, wherein the instructions further comprise instructions that when executed cause the programmable device to:
take an anti-malware action responsive to a determination that a malware exploit has occurred, wherein the anti-malware action comprises one or more of termination or changing a sensitivity of a monitoring behavior of a program that triggered the malware exploit.

9. A programmable device programmed to detect malware exploits, comprising:
a processor, comprising:
a performance monitoring unit; and
a last branch record stack; and
a memory, coupled to the processor, on which are stored instructions, comprising instructions that when executed cause the processor to:
configure the performance monitoring unit to count mispredicted branches;
configure the last branch record stack to capture a predetermined category of branches;
collect mispredicted branch counts and last branch data from the performance monitoring unit and last branch record stack, responsive to an interrupt generated upon a predetermined condition of the performance monitoring unit; and
analyze the mispredicted branch counts and the last branch data to determine whether a malware exploit has occurred.

10. The programmable device of claim 9, wherein the malware exploit is a return-oriented programming exploit.

11. The programmable device of claim 10, wherein the instructions that when executed cause the processor to analyze the mispredicted branch counts and the last branch data comprise instructions that when executed cause the processor to:
increment a return-oriented programming event counter responsive to a last branch instance having a from address pointing to a return instruction and a to address pointing to an instruction not following a call instruction; and
indicate a return-oriented programming exploit has occurred responsive to the return-oriented programming event counter meeting or exceeding a predetermined threshold value.

12. The programmable device of claim 10, wherein the predetermined category of branches comprises return instructions.

13. The programmable device of claim 9, wherein the malware exploit is a jump-oriented programming exploit.

14. The programmable device of claim 13, wherein the instructions that when executed cause the processor to analyze the mispredicted branch counts and the last branch data comprise instructions that when executed cause the processor to:
look for a sequence of last branch instances having from addresses pointing to an indirect jump instruction with an alternating constant address of a dispatcher's entry point and leave point.

15. The programmable device of claim 13, wherein the predetermined category of branches comprises near indirect jump instructions.

16. The programmable device of claim 9, wherein the instructions further comprise instructions that when executed cause the processor to:
take an anti-malware action responsive to a determination that that a malware exploit has occurred.

17. A method of detecting malware exploits, comprising:
counting mispredicted branches in a performance monitoring unit of a processor;
capturing last branch information by the processor;
collecting a mispredicted branch count and the last branch information responsive to a performance monitoring interrupt; and
determining whether a malware exploit has occurred based on the mispredicted branch count and last branch information.

18. The method of claim 17, wherein counting mispredicted branches comprises configuring a control register of the performance monitoring unit to cause the performance monitoring unit to count mispredicted branches.

19. The method of claim 17, further comprising: configuring the performance monitoring unit to generate the performance monitoring interrupt responsive to counting a threshold number of mispredicted branches.

20. The method of claim 17, wherein capturing last branch information comprises:
configuring a last branch record unit to capture return instruction branches.

21. The method of claim 17, wherein capturing last branch information comprises:
configuring a last branch record unit to capture near indirect jump branches.

22. The method of claim 17, wherein the malware exploit is a return-oriented programming exploit, and
wherein determining whether a malware exploit has occurred comprises:
counting occurrences of a last branch instance having a from address pointing to a return instruction and a to address pointing to an instruction not following a call instruction; and
indicating the malware exploit has occurred responsive to a threshold number of occurrences.

23. The method of claim 17, wherein the malware exploit is a jump-oriented programming exploit, and
wherein determining whether a malware exploit has occurred comprises:
finding a sequence of last branch instances having from addresses pointing to an indirect jump instructions alternating with a constant address of a dispatcher entry point or leave point.

24. The method of claim 17, further comprising:
taking an anti-malware action responsive to the determination that an exploit has occurred.

25. The method of claim 17, wherein determining whether a malware exploit has occurred comprises detecting whether either of a return-oriented programming exploit or a jump-oriented programming exploit has occurred.
